(19) United States
(12) Patent Application Publication
(10) Pub. No.: US 2017/0358003 A1
(43) Pub. Date: Dec. 14, 2017

(54) OBJECT RECOGNITION BASED RETARGETING ADVERTISEMENT PRODUCT RECOMMENDING SERVER, CONTROL METHOD THEREOF, AND NON-TRANSITORY COMPUTER READABLE STORAGE MEDIUM HAVING COMPUTER PROGRAM RECORDED THEREON

(71) Applicant: SK Planet Co., Ltd., Gyeonggi-do (KR)

(72) Inventor: Min Ho HAN, Seoul (KR)

(73) Assignee: SK Planet Co., Ltd., Gyeonggi-do (KR)

(21) Appl. No.: 15/320,579

(22) PCT Filed: Dec. 2, 2015
(86) PCT No.: PCT/KR2015/013013

§ 371 Date: Dec. 20, 2016

(30) Foreign Application Priority Data
Feb. 11, 2015 (KR) 10-2015-0020628

(51) Int. Cl. G06Q 30/02

(52) U.S. Cl. CPC G06Q 30/0256; G06Q 30/0267

(57) ABSTRACT

Disclosed are an object recognition based retargeting advertisement product recommending terminal, a server, an advertisement product recommending system including the same, a control method thereof, and a non-transitory computer readable storage medium having computer program recorded thereon. That is, when a terminal requests an advertisement, a tracking log including information on an advertisement, and the like, which has been searched before in the terminal and an advertisement related to an object corresponding to a unique ID of the object which is registered in advance in an advertising terminal matching a unique ID of the object corresponding to unique identification information of the terminal are provided to the terminal. Therefore, an advertisement suitable for a user may be transmitted through intuitive analysis of a favorable impression of a product of an advertisement receiver and thus an advertisement effect is increased.

### TECHNICAL FIELD

The present invention relates to an object recognition based retargeting advertisement product recommending server, a control method thereof, and a non-transitory computer readable storage medium having a computer program recorded thereon, and more particularly, to an object recognition based retargeting advertisement product recommending server which, when a terminal requests an advertisement, provides a tracking log including information on an advertisement, and the like, which has been searched before in the terminal and an advertisement related to an object corresponding to a unique ID of the object which is registered in advance in an advertising terminal matching a unique ID of the object corresponding to unique identification information of the terminal, to the terminal, a control method thereof, and a non-transitory computer readable storage medium having a computer program recorded thereon.

### BACKGROUND ART

It is over 20 years since World Wide Web (WWW) which popularizes the Internet service has been grown. The Internet advertisement starts in the form of a banner on an HOTWIRED on October of 1994, which is two years later after establishing an original website on 1992. It may be said that a text type advertisement based on a PC communication is the beginning of the Internet advertisement. However, a current style of Internet advertisement which may interact with a user starts from an advertisement of HOTWIRED in the United States.

The advertisement posted on HOTWIRED was born to promote a website of youwill.com while AT&T conducted a campaign through the website on September of 1994. Hotwired.com persuaded AT&T to host an online banner advertisement for the first time and a sentence saying “Have you ever clicked your mouse right HERE” was inserted in the first banner advertisement to induct people to click the banner, which was an epoch-making idea at that time.

Starting from this, an Internet advertisement was introduced on 1994 in this country and has been developed from a simple banner advertisement to a banner which delivers more messages in accordance with development of a multimedia technology. At this time, the internet advertisement has been earnestly acknowledged as an alternative of a traditional medium and thus developed to various types such as electronic mail or webzine.

Thereafter, the number of Internet users reached ten million on 1999 and exceeded thirty million on 2004. Further, the Internet advertisement grows in accordance with rapid Internet propagation, so that a new type of advertisement such as display AD and search AD appears.

On 2006, as a WiBro and HSDPA service start in this country for the first time in the World, usage of wired Internet shows signs of stagnation and the users rapidly transfer to a mobile Internet. Therefore, a customized advertisement using personal information is tried from a new Internet business.

A background in which an Internet, a mobile advertisement industry grows as a second generation advertisement media after beating printed media is that the mobile advertisement provides a message based on characteristics such as a receiver selectivity, real-time property, localization, interaction beyond time and paper restriction of the existing advertisement media.

### RELATED ART DOCUMENT

### Patent Document

Korean Unexamined Patent Application Publication No. 10-2000-0030058 (entitled Advertising system and method using Internet web page]

### DISCLOSURE

### Technical Problem

An object of the present invention is to provide an object recognition based retargeting advertisement product recommending server, a control method thereof, and a non-transitory computer readable storage medium having computer program recorded thereon which, when a terminal requests an advertisement, provides a tracking log including information on an advertisement, and the like, which has been searched before in the terminal and an advertisement related to an object corresponding to a unique ID of the object which is registered in advance in an advertising terminal matching a unique ID of the object corresponding to unique identification information of the terminal, to the terminal.

### Technical Solution

According to an aspect of the present invention, an object recognition based retargeting advertisement product recommending server includes a communication unit which receives an advertisement transmitting request signal and identification information of the terminal which are transmitted from a terminal; a storage unit which stores a plurality of first index information including a plurality of object IDs corresponding to objects discerned in multimedia contents and identification information, a plurality of second index information including a plurality of object IDs corresponding to objects discerned in product information and advertisement IDs corresponding to the object IDs, a plurality of advertisements, and tracking log information for every terminal; and a control unit which confirms one or more first advertisements and at least one second advertisement based on at least one of the identification information of the terminal, the plurality of first index information, the plurality of second index information, the plurality of advertisements, and the tracking log information for every terminal, and controls the communication unit to transmit the confirmed one or more first advertisements and at least one second advertisement to the terminal.

In an embodiment of the present invention, the control unit may confirm tracking log information corresponding to the received identification information of the terminal among the tracking log information for every terminal and confirm one or more first advertisements corresponding to the confirmed tracking log information among the plurality of advertisements which is stored in advance in the storage unit.

In an embodiment of the present invention, the control unit may confirm at least one object ID in first index information corresponding to the identification information of the terminal among the plurality of first index information, confirm at least one advertisement ID corresponding to at least one confirmed object ID, respectively, among the plurality of second index information, and confirm at least one second advertisement corresponding to the at least one confirmed advertisement ID, respectively, among the plurality of advertisements which is stored in advance in the storage unit.

In an embodiment of the present invention, the tracking log information may include at least one of product information which is previously searched by a specific terminal, product view information, product information put in a cart of the specific terminal, and product information for which payment is completed by the specific terminal.

In an embodiment of the present invention, the control unit may extract feature information in the multimedia contents, discerns an object included in the multimedia contents based on the extracted feature information, generate the first index information including an object ID which is set in advance correspondingly to the discerned object and the identification information of the terminal, and store the generated first index information in the storage unit.

In an embodiment of the present invention, the control unit may extract feature information in product information transmitted from an advertisement terminal, discern an object included in the product information based on the extracted feature information, generate the second index information including an object ID which is set in advance correspondingly to the discerned object and an advertisement ID which is set in advance correspondingly to the object ID, and store the generated second index information in the storage unit.

According to another aspect of the present invention, a control method of an object recognition based retargeting advertisement product recommending server, the control method includes: receiving an advertisement transmitting request signal and identification information of the terminal transmitted from a terminal, by means of a communication unit; confirming one or more first advertisements based on tracking log information for every terminals which is stored in advance in a storage unit and the identification information of the terminal, by means of a control unit; confirming at least one advertisement ID matching an object ID in first index information corresponding to the identification information of the terminal among a plurality of second index information which is stored in advance in the storage unit and confirming at least one second advertisement corresponding to the confirmed at least one advertisement ID, by means of the control unit; and transmitting the confirmed one or more first advertisements and at least one second advertisement to the terminal, by means of the communication unit.

In an embodiment of the present invention, the confirming of one or more first advertisements may include confirming tracking log information corresponding to the received identification information of the terminal among the tracking log information for every terminal, by means of the control unit; and confirming one or more first advertisements corresponding to the confirmed tracking log information, among the plurality of advertisement which is stored in advance in the storage unit.

In an embodiment of the present invention, the confirming of at least one second advertisement may include confirming at least one object ID in first index information corresponding to the identification information of the terminal, among a plurality of first index information; confirming at least one advertisement ID corresponding to the confirmed at least one object ID, respectively, among the plurality of second index information; and confirming at least one second advertisements corresponding to the confirmed at least one advertisement ID, respectively, among the plurality of advertisement which is stored in advance in the storage unit.

A computer program implementing the method according to the embodiment may be stored in a non-transitory computer readable storage medium having a computer program recorded thereon.

### Advantageous Effects

According to the present invention, when a terminal requests an advertisement, a tracking log including information on an advertisement, and the like, which has been searched before in the terminal and an advertisement related to an object corresponding to a unique ID of the object which is registered in advance in an advertising terminal matching a unique ID of the object corresponding to unique identification information of the terminal are provided to the terminal. Therefore, an advertisement suitable for a user may be transmitted through intuitive analysis of a favorable impression of a product of an advertisement receiver and thus an advertisement effect is increased. Further, a high purchasing rate may be achieved by providing advertisement on a product necessary in the daily life.

### BRIEF DESCRIPTION OF THE DRAWINGS

FIG. 1 is a block diagram illustrating a configuration of an advertisement product recommending system according to an embodiment of the present invention.

FIG. 2 is a block diagram illustrating a configuration of a terminal according to an embodiment of the present invention.

FIG. 3 is a block diagram illustrating a configuration of an advertising terminal according to an embodiment of the present invention.

FIG. 4 is a block diagram illustrating a configuration of an object recognition based retargeting advertisement product recommending server according to an embodiment of the present invention.

FIG. 5 is a flowchart illustrating a control method of an object recognition based retargeting advertisement product recommending server according to a first embodiment of the present invention.

FIG. 6 is a view illustrating first index information according to a first embodiment of the present invention.

FIG. 7 is a flowchart illustrating a control method of an object recognition based retargeting advertisement product recommending system according to a second embodiment of the present invention.

FIG. 8 is a view illustrating second index information according to a second embodiment of the present invention.

FIG. 9 is a flowchart illustrating a control method of an object recognition based retargeting advertisement product recommending system according to a first embodiment of the present invention.

FIG. 10 is a view illustrating a screen of a terminal according to a third embodiment of the present invention.

### MODE FOR INVENTION

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not be included or additional components or steps may be further included.

In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

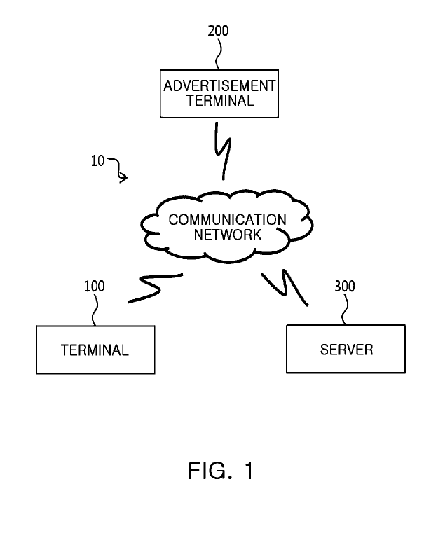

FIG. 1 is a block diagram illustrating a configuration of an advertisement product recommending system 10 according to an embodiment of the present invention.

As illustrated in FIG. 1, the advertisement product recommending system 10 includes a terminal 100, an advertising terminal 200, and a server 300. All the constituent elements of the advertisement product recommending system 10 illustrated in FIG. 1 are not essential constituent elements, and the advertisement product recommending system 10 may be implemented by more constituent elements than the constituent elements illustrated in FIG. 1 or less constituent elements therethan.

The server 300 receives multimedia contents including an object and identification information of the terminal 100 which are transmitted from the terminal 100.

Thereafter, the server 300 extracts feature information in the received multimedia contents and identifies an object in the multimedia contents based on the extracted feature information. Thereafter, the server 300 generates and stores first index information (or object relationship information/object relationship table) including an object ID corresponding to the identified object, the identification information of the terminal, and the like.

The server 300 further receives product information including an object, tracking log information for every terminal, and identification information of the advertising terminal 200 which are transmitted from the advertising terminal 200. Thereafter, the server 300 extracts feature information in the received product information and identifies an object in the product information based on the extracted feature information. Thereafter, the server 300 generates and stores second index information (or object advertisement relationship information/object advertisement relationship table) including an object ID corresponding to the identified object, an advertisement ID corresponding to the object ID, and the like.

Further, the server 300 receives an advertisement transmitting request signal, the identification information of the terminal 100, and the like from the terminal 100. Thereafter, the server 300 confirms tracking log information related to the terminal 100 among the tracking log information for every terminal which is stored in advance and confirms (or searches) one or more first advertisement corresponding to the confirmed tracking log information among the plurality of advertisements which is stored in advance. Further, the server 300 confirms a unique ID of the object in the first index information corresponding to the identification information of the terminal 100 among a plurality of first index information which is stored in advance, confirms an advertisement ID corresponding to the unique ID of the previously confirmed object among a plurality of second index information which is stored in advance, and confirms at least one second advertisement corresponding to the previously confirmed advertisement ID among the plurality of advertisements which is stored in advance. Thereafter, the server 300 provides one or more confirmed first advertisement and at least one confirmed second advertisement to the terminal 100.

The terminal 100 (or a user side device) and/or the advertising terminal 200 may be applied to various terminals such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an ultrabook, a wearable device (for example, including a smart watch, a smart glass, a head mounted display (HMD), or the like), a Wibro terminal, an internet protocol television (IPTV) terminal, a smart TV, a digital broadcasting terminal, a television, a 3D television, a home theater system, an audio video navigation (AVN) terminal, an audio/video (A/V) system, and a flexible terminal.

Further, the terminal 100 and/or the advertising terminal 200 may be a terminal including a memory in which a browser, a program, and a protocol are stored to communicate with the server 300 via a communication network, a microprocessor which executes various programs to perform calculation and control, and the like.

That is, if it is possible to communicate with the server 300, any of terminals may be used as the terminal 100 and/or the advertising terminal 200.

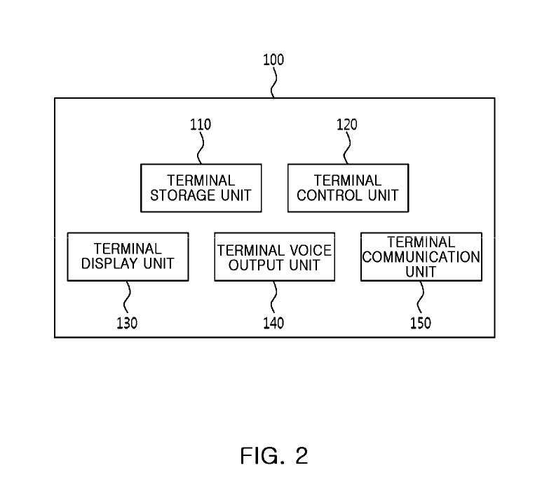

As illustrated in FIG. 2, the terminal 100 is constituted by a terminal storage unit 110, a terminal control unit 120, a terminal display unit 130, a terminal voice output unit 140, and a terminal communication unit 150. However, all the constituent elements of the terminal 100 illustrated in FIG. 2 are not essential constituent elements, and the terminal 100 may be implemented by more constituent elements than the constituent elements illustrated in FIG. 2 or less constituent elements therethan.

The terminal storage unit 110 stores various user interfaces UI, graphic user interfaces GUI, and the like.

Further, the terminal storage unit 110 stores data and programs which are required to operate the terminal 100.

That is, the terminal storage unit 110 may store a plurality of application programs (or applications) which are driven in the terminal 100 and data and commands for operation of the terminal 100. At least some of the application programs may be downloaded from an external server through wireless communication. In the meantime, the application program is stored in the terminal storage unit 110 and installed in the terminal 100 to be driven to perform an operation (or a function) of the terminal 100 by the terminal control unit 120.

Further, the terminal storage unit 110 may include at least one storage medium of a flash memory type, a hard disk type, a multimedia card micro type, a card type memory (for example, an SD, XD memory, or the like), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the terminal 100 may operate a web storage which performs a storing function of the terminal storage unit 110 on the Internet or operate in association with the web storage.

Further, the terminal storage unit 110 may store multimedia contents (for example, including an image and a moving image) photographed by a camera unit (not illustrated) equipped in the terminal by the control of the terminal control unit 120.

The terminal control unit 120 performs an overall control function of the terminal 100.

Further, the terminal control unit 120 performs an overall control function of the terminal 100 using a program and data stored in the terminal storage unit 110. The terminal control unit 120 may include a RAM, a ROM, a CPU, a GPU, and a bus and the RAM, the ROM, the CPU, the GPU, and the like are connected to each other through the bus. The CPU may access the terminal storage unit 110 to perform booting using an O/S stored in the terminal storage unit 110 and perform various operations using various programs, contents, and data stored in the terminal storage unit 110.

Further, the terminal control unit 120 performs a member joining procedure for a user of the terminal 100 in association with the server 300.

Further, when the member joining procedure is performed, the terminal control unit 120 normally completes the member joining procedure for the server 300 only by completing an authentication function through a self-authentication unit (for example, including a mobile phone, a credit card, I-PIN, e-mail, and the like).

Further, when an application which is installed in advance in the terminal 100 is executed, the terminal control unit 120 displays an application executing result screen on the terminal display unit 130.

Further, the terminal control unit 120 controls the terminal communication unit 150 to be connected to the server 300 (or to perform a communication function).

Further, when the application which is installed in advance in the terminal 100 is executed or the terminal 100 accesses the server 300, the terminal control unit 120 transmits one or more multimedia contents which are stored in advance in the terminal storage unit 110, identification information of the terminal 100, and the like to the server 300 through the terminal communication unit 150. Here, the multimedia contents include an image, a moving image, and the like. Further, the identification information of the terminal 100 includes a mobile directory number (MDN), a mobile IP, a mobile MAC, a subscriber identify module (Sim) card unique information, and a serial number.

Further, in a state when the application which is installed in advance in the terminal 100 is executed or the terminal 100 accesses the server 300, if a predetermined advertisement transmitting request menu (alternatively, an advertisement transmitting request button) is selected, the terminal control unit 120 generates an advertisement transmitting request signal.

Further, the terminal control unit 120 transmits the advertisement transmitting request signal, the identification information of the terminal 100, and the like to the server 300 through the terminal communication unit 150.

Further, the terminal control unit 120 receives one or more first advertisements corresponding to the tracking log information transmitted from the server 300 in response to the transmitted advertisement transmitting request signal, at least one second advertisement corresponding to the advertisement ID, and the like through the terminal communications 150.

Further, the terminal control unit 120 outputs one or more first advertisements corresponding to the received tracking log information, at least one second advertisement corresponding to the advertisement ID, and the like, by means of the terminal display unit 130 and/or the terminal voice outputting unit 140.

The terminal display device 130 may display various contents such as various menu screens using the user interface and/or graphic user interface stored in the terminal storage unit 110, by the control of the terminal control unit 120. Here, the contents displayed on the terminal display unit 130 may include a menu screen including various texts, image data (including various information data), and data such as icons, list menus, or a combo boxes. Further, the terminal display unit 130 may be a touch screen. In this case, a touch sensor which detects a touch gesture of the user may be included. The touch sensor may be any one of various types such as a capacitive type, a decompressive type, or a piezoelectric type. In the case of the capacitive type, when a part of a user's body touches a surface of the touch screen by using a dielectric coated on the surface of the touch screen, a touch coordinate is calculated by sensing minute electricity excited to the user's body. In the case of the decompressive type, two electrode plates are embedded in the touch screen, and when the user touches the screen, upper and lower electrode plates contact each other at the touched position and then current flows, and the touch coordinate is calculated by sensing the flow of the current. In addition to this, the user device supports a pen input function. In this case, a gesture of the user utilizing an input unit such as a pen, rather than the part of the body of the user, may be sensed. For example, when the input unit is a stylus pen in which a coil is included, the user device may include a magnetic field sensor for sensing a magnetic field changed by the coil in the stylus pen. In this case, an approaching gesture of the user such as hovering in addition to the touch gesture of the user may be sensed.

Further, the terminal display unit 130 may be implemented by at least one of a liquid crystal display (LCD), a thin film transistor liquid crystal display (TFT LCD), an organic light emitting diode (OLED), a flexible display, a three dimensional display (3D display), an electronic ink (e-ink) display, and a light emitting diode (LED) and also include a driving circuit therefor and a back light unit together.

Further, the terminal display unit 130 displays one or more first advertisement corresponding to the tracking log information transmitted from the server 300 by the control of the terminal control unit 120, at least one second advertisement corresponding to the advertisement ID, and the like.

Further, the terminal display unit 130 may be constituted as a stereoscopic display unit which displays a stereoscopic image.

A 3D display type such as a stereoscopic type (a glasses type), an auto-stereoscopic type (a glassless type), and a projection type (a holographic type) may be applied to the stereoscopic display unit.

The terminal voice output unit 140 outputs voice information included in a predetermined signal-processed signal by the terminal control unit 120. Here, the terminal voice output unit 140 may include a receiver, a speaker, a buzzer, and the like.

Further, the terminal voice output unit 140 outputs a guidance voice generated by the terminal control unit 120.

Further, the terminal voice output unit 140 outputs voice information corresponding to one or more first advertisement corresponding to the tracking log information transmitted from the server 300 by the terminal control unit 120, voice information corresponding to at least one second advertisement corresponding to the advertisement ID, and the like.

The terminal communication unit 150 communicates with any internal constituent element or at least one external terminal via a wired/wireless communication network. In this case, the external terminal may include the advertising terminal 200 and the server 300. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The terminal communication unit 150 transmits and receives data in accordance with at least one wireless Internet technique within a range including also Internet techniques which are not listed above. Further, the short range communication technique may include Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, or the like. Furthermore, the wired communication technique may include power line communication (PLC), USB communication, Ethernet, serial communication, an optical/coaxial cable, or the like.

Further, the terminal communication unit 150 may mutually transmit information with any terminal through a universal serial bus (USB).

Further, the terminal communication unit 150 transmits one or more multimedia contents stored in the terminal storage unit 110 by the control of the terminal control unit 120, the identification information of the terminal 100 to the server 300, and the like.

Further, the terminal communication unit 150 transmits the advertisement transmitting request signal, the identification information of the terminal 100, and the like to the server 300 by the control of the terminal control unit 120.

Further, the terminal communication unit 150 receives one or more first advertisements corresponding to the tracking log information which is transmitted from the server 300 in response to the transmitted advertisement transmitting request signal by the control of the terminal control unit 120 and is confirmed in the server 300 and at least one second advertisement corresponding to the advertisement ID confirmed in the server 300.

Further, the terminal 100 may further include an interface unit (not illustrated) serving as an interface with all external apparatuses which are connected to the terminal 100. For example, the interface unit may be constituted by a wired/wireless headset port, an external charger port, a wired/wireless data port, a memory card port, a port connecting devices with identification modules, an audio input/output (I/O) port, a video input/output (I/O) port, an earphone port, and the like. Here, the identification module is a chip which stores various information for authenticating a permission of the terminal 100 and may include a user identity module (UIM), a subscriber identity module (SIM), a universal subscriber identity module (USIM), and the like. Further, the device provided with the identification module may be prepared in a smart card form. Accordingly, the identification module may be connected with the terminal 100 through the port. Such an interface unit receives data or power from an external device to transmit the received data or power to each constituent element in the terminal 100 or transmit the data in the terminal 100 to the external device.

Further, the interface unit may be a passage through which the power from a cradle is supplied to the corresponding terminal 100 when the terminal 100 is connected to an external cradle or a passage through which various command signals input from the cradle by the user is transferred to the corresponding terminal 100. Various command signals input from the cradle or the corresponding power may also operate by a signal for recognizing that the terminal 100 is accurately installed on the cradle.

Further, the terminal 100 may further include an input unit (not illustrated) for receiving a signal according to a button operation of the user or any function selection or receiving a command or a control signal created by an operation such as an operation of touching/scrolling the displayed screen.

The input unit as a means for receiving at least one of a user's command, selection, data, and information may include a plurality of input keys and function keys for receiving figure or text information and setting various functions.

Further, the input unit may use various devices such as a key pad, a dome switch, a touch pad (a pressure resistive type/a contact capacitive type), a touch screen, a jog wheel, a jog switch, a jog shuttle, a mouse, a stylus pen, and a touch pen. Particularly, when the terminal display unit 130 is formed in a touch screen form, some or all of the input functions may be performed by the terminal display unit 130.

Further, each constituent element (or each module) of the terminal 100 may be software stored on a memory (or the terminal storage unit 110) of the terminal 100. The memory may be an internal memory of the terminal 100 and may an external memory or other types of storage devices. Further, the memory may be a non-volatile memory. The software stored on the memory may include a command set to allow the terminal 100 to perform a specific operation while executing.

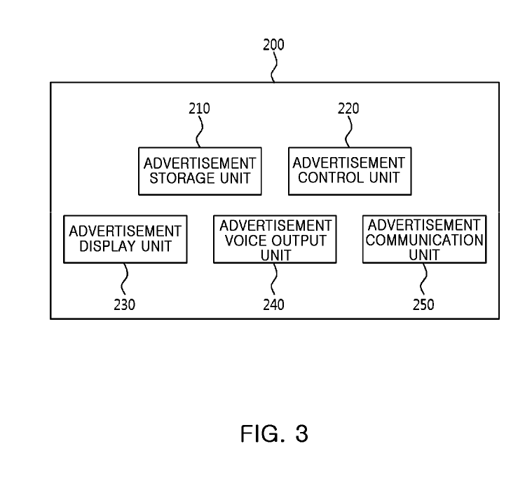

As illustrated in FIG. 3, the advertising terminal 200 is constituted by an advertisement storage unit 210, an advertisement control unit 220, an advertisement display unit 230, an advertisement voice output unit 240, and an advertisement communication unit 250. However, all the constituent elements of the advertising terminal 200 illustrated in FIG. 3 are not essential constituent elements, and the advertising terminal 200 may be implemented by more constituent elements than the constituent elements illustrated in FIG. 3 or less constituent elements therethan.

The advertisement storage unit 210 stores various user interfaces UI, graphic user interfaces GUI, and the like.

Further, the advertisement storage unit 210 stores data and programs which are required to operate the advertisement terminal 200.

That is, the advertisement storage unit 210 may store a plurality of application programs (or applications) which are driven in the advertisement terminal 200 and data and commands for operation of the advertisement terminal 200. At least some of the application programs may be downloaded from an external server through wireless communication. In the meantime, the application program is stored in the advertisement storage unit 210 and installed in the advertisement terminal 200 to be driven to perform an operation (or a function) of the advertisement terminal 200 by the advertisement control unit 220.

Further, the advertisement storage unit 210 may include at least one storage medium of a flash memory type, a hard disk type, a multimedia card micro type, a card type memory (for example, an SD, XD memory, or the like), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the advertisement terminal 200 may operate a web storage which performs a storing function of the advertisement storage unit 210 on the Internet or operate in association with the web storage.

Further, the advertisement storage unit 210 stores one or more advertisement (or advertisement contents) generated (or created) by an advertisement copywriter by the control of the advertisement control unit 220.

The advertisement control unit 220 performs an overall control function of the advertisement terminal 200.

Further, the advertisement control unit 220 performs an overall control function of the advertisement terminal 200 using a program and data stored in the advertisement storage unit 210. The advertisement control unit 220 may include a RAM, a ROM, a CPU, a GPU, and a bus and the RAM, the ROM, the CPU, the GPU, and the like are connected to each other through the bus. The CPU accesses the advertisement storage unit 210 to perform booting using an O/S stored in the advertisement storage unit 210 and performs various operations using various programs, contents, and data stored in the advertisement storage unit 210.

Further, the advertisement control unit 220 performs a member joining procedure for a user of the advertisement terminal 200 in association with the server 300.

Further, when the member joining procedure is performed, the advertisement control unit 220 may normally complete the member joining procedure for the server 300 only by completing an authentication function through a self-authentication unit (for example, including a mobile phone, a credit card, I-PIN, e-mail, and the like).

Further, the advertisement control unit 220 generates (or creates) one or more advertisements (or advertisement contents) by an advertisement copywriter and stores one or more generated advertisements in the advertisement storage unit 210.

Further, the advertisement control unit 220 stores a plurality of (or one or more) product information in the advertisement storage unit 210. Here, the product information includes a product name, a product image, and product description information.

Further, the advertisement control unit 220 is provided with tracking log information for every terminal including information on a product which is searched or purchased by one or more terminal 100 through a specific online site (for example, including a home shopping or a shopping mall), from an online site server (not illustrated) and stores the provided tracking log information for every terminal in the advertisement storage unit 210. Here, the tracking log information includes product information searched by the specific terminal 100, product view information, cart information (or product information put in a cart of the specific terminal), order information (or product information for which payment is completed by the specific terminal), and the like.

Further, when the application which is installed in advance in the advertisement terminal 200 is executed or the advertisement terminal 200 accesses the server 300, the advertisement control unit 220 transmits a plurality of (or one or more) product information which is stored in advance in the advertisement storage unit 210, tracking log information for every terminal, and identification information of the advertisement terminal 200 to the server 300 through the advertisement communication unit 250.

As described above, the advertisement terminal 200 performs a function of transmitting the generated advertisement to the server 300, a function of transmitting product information collected in real time to the server 300, a function of transmitting the tracking log information for a specific terminal 100 to the server 300, and the like.

The advertisement display device 230 may display various contents such as various menu screens using a user interface and/or graphic user interface stored in the advertisement storage unit 210, by the control of the advertisement control unit 220. Here, the contents displayed on the advertisement display unit 230 may include a menu screen including various texts, or image data (including various information data), and data such as icons, list menus, or a combo boxes. Further, the advertisement display unit 230 may be a touch screen. In this case, a touch sensor which detects a touch gesture of the user may be included. The touch sensor may be any one of various types such as a capacitive type, a decompressive type, or a piezoelectric type. In the case of the capacitive type, when a part of a user's body touches a surface of the touch screen by using a dielectric coated on the surface of the touch screen, a touch coordinate is calculated by sensing minute electricity excited to the user's body. In the case of the decompressive type, two electrode plates are embedded in the touch screen, and when the user touches the screen, upper and lower electrode plates contact each other at the touched position and then current flows, and the touch coordinate is calculated by sensing the flow of the current. In addition to this, the user device supports a pen input function. In this case, a gesture of the user utilizing an input unit such as a pen, rather than the part of the body of the user, may be sensed. For example, when the input unit is a stylus pen in which a coil is included, the user device may include a magnetic field sensor for sensing a magnetic field changed by the coil in the stylus pen. In this case, not only the touch gesture of the user, but also approaching gesture of the user, such as hovering may be detected.

Further, the advertisement display unit 230 may be implemented by at least one of a liquid crystal display (LCD), a thin film transistor liquid crystal display (TFT LCD), an organic light emitting diode (OLED), a flexible display, a three dimensional display (3D display), an electronic ink (e-ink) display, and a light emitting diode (LED) and also include a driving circuit therefor and a back light unit together.

Further, the advertisement display unit 230 displays the advertisement generated by the control of the advertisement control unit 220.

Further, the advertisement display unit 230 displays a plurality (or one or more) of product information by the control of the advertisement control unit 220.

Further, the advertisement display unit 230 displays the tracking log information for every terminal by the control of the advertisement control unit 220.

Further, the advertisement display unit 230 may be configured as a stereoscopic display unit which displays a stereoscopic image. Herein, a 3D display type such as a stereoscopic type (a glasses type), an auto-stereoscopic type (a glassless type), and a projection type (a holographic type) may be applied to the stereoscopic display unit.

The advertisement voice output unit 240 outputs voice information included in a predetermined signal-processed signal by the advertisement control unit 220. Herein, the advertisement voice output unit 240 may include a receiver, a speaker, and a buzzer.

Further, the advertisement voice output unit 240 outputs a guidance voice generated by the advertisement control unit 220.

Further, the advertisement voice output unit 240 outputs voice information corresponding to the advertisement generated by the control of the advertisement control unit 220.

Further, the advertisement voice output unit 240 outputs voice information corresponding to the plurality (or one or more) of product information by the control of the advertisement control unit 220.

Further, the advertisement voice output unit 240 outputs voice information corresponding to the tracking log information for every terminal by the control of the advertisement control unit 220.

The advertisement communication unit 250 communicates with any internal constituent element or at least one external terminal via a wired/wireless communication network. In this case, the external terminal may include the terminal 100 and the server 300. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The advertisement communication unit 250 transmits and receives data in accordance with at least one wireless Internet technique within a range including Internet techniques which are not listed above. Further, a short range communication technique may include Bluetooth, radio frequency identification (RFID), infrared data association (IrDA), ultra-wideband (UWB), ZigBee, near field communication (NFC), ultra sound communication (USC), visible light communication (VLC), Wi-Fi, and Wi-Fi direct. Further, a wired communication technique may include power line communication (PLC), USB communication, Ethernet, serial communication, or an optical/coaxial cable.

Further, the advertisement communication unit 250 may mutually transmit information with any terminal through a universal serial bus (USB).

Further, the advertisement communication unit 250 transmits one or more advertisements which are stored in the advertisement storage unit 210 in advance to the server 300 by the control of the advertisement control unit 220.

Further, the advertisement communication unit 250 transmits a plurality (or one or more) of product information which is stored in the advertisement storage unit 210 in advance, tracking log information for every terminal, identification information of the advertisement terminal 200, and the like to the server 300 by the control of the advertisement control unit 220. Here, the product information includes a product name, a product image, and product description information. Further, the tracking log information includes product information searched by the specific terminal 100, product view information, cart information (or product information put in a cart of the specific terminal), order information (or product information for which payment is completed by the specific terminal), and the like.

Further, each constituent element (or each module) of the advertisement terminal 200 may be software stored on a memory (or the advertisement storage unit 210) of the advertisement terminal 200. The memory may be an internal memory of the advertisement terminal 200 and may an external memory or other types of storage devices. Further, the memory may be a non-volatile memory. The software stored on the memory may include a command set to allow the advertisement terminal 200 to perform a specific operation while executing.

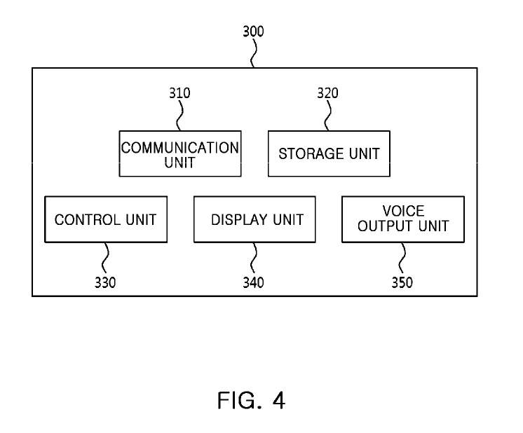

As illustrated in FIG. 4, an object recognition based retargeting advertisement product recommending server (or server) 300 is constituted by a communication unit 310, a storage unit 320, a control unit 330, a display unit 340, and a voice output unit 350. However, all the constituent elements of the server 300 illustrated in FIG. 4 are not essential constituent elements, and the server 300 may be implemented by more constituent elements than the constituent elements illustrated in FIG. 4 or less constituent elements therethan.

The communication unit 310 communicates with any internal constituent element or at least one external terminal via a wired/wireless communication network. In this case, the external terminal may include the terminal 100 and the advertisement terminal 200. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The communication unit 310 transmits and receives data in accordance with at least one wireless Internet technique within a range including Internet techniques which are not listed above. Further, the short range communication technique may include Bluetooth, radio frequency identification (RFID), infrared data association (IrDA), ultra wideband (UWB), ZigBee, near field communication (NFC), ultra sound communication (USC), visible light communication (VLC), Wi-Fi, Wi-Fi direct, or the like. Further, a wired communication technique may include power line communication (PLC), USB communication, Ethernet, serial communication, or an optical/coaxial cable.

Further, the communication unit 310 may mutually transmit information with any terminal through a universal serial bus (USB).

Further, the communication unit 310 receives one or more multimedia contents transmitted from the terminal 100, the identification information of the terminal 100, and the like by the control of the control unit 330.

Furthermore, the communication unit 310 receives one or more advertisements transmitted from the advertisement terminal 200 by the control of the control unit 330.

Further, the communication unit 310 receives product information, the tracking log information for every terminal, and identification information of the advertisement terminal 200 which are transmitted from the advertisement terminal 200 by the control of the control unit 330.

Further, the communication unit 310 receives an advertisement transmitting request signal and identification information of the terminal 100 which are transmitted from the terminal 100 by the control of the control unit 330.

Further, the communication unit 310 transmits one or more first advertisement corresponding to the tracking log information, at least one second advertisement corresponding to the advertisement ID, and the like to the terminal 100 in response to the advertisement transmitting request signal by the control of the control unit 330.

The storage unit 320 stores various user interfaces UI, graphic user interfaces GUI, and the like.

Further, the storage unit 320 stores data and programs required to operate the server 300.

That is, the storage unit 320 may store a plurality of application programs which are driven in the server 300 and data and commands for operation of the server 300. At least some of the application programs may be downloaded from an external server through wireless communication. In the meantime, the application program is stored in the storage unit 320 and installed on the server 300 to be driven to perform an operation (or a function) of the server 300 by the control unit 330.

Further, the storage unit 320 may include at least one storage medium of a flash memory type, a hard disk type, a multimedia card micro type, a card type memory (for example, an SD, XD memory, or the like), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the server 300 may operate a web storage which performs a storing function of the storage unit 320 on the Internet or operate in association with the web storage.

Further, the storage unit 320 stores one or more multimedia contents, identification information of the terminal 100, one or more advertisements, product information, tracking log information for every terminal, identification information of the advertisement terminal 200, and an advertisement transmitting request signal which are received through the communication unit 310, by the control of the control unit 330.

Further, the storage unit 320 stores feature information for every object by the control of the control unit 330. In this case, the feature information may be continuously updated by learning using a deep learning technique by the control of the control unit 330. As described above, the control unit 330 may calculate accuracy of object recognition by a probability based on the learned feature information.

The control unit 330 performs an overall control function of the server 300.

Further, the control unit 330 performs an overall control function of the server 300 using a program and data stored in the storage unit 320. The control unit 330 may include a RAM, a ROM, a CPU, a GPU, and a bus and the RAM, the ROM, the CPU, the GPU, and the like are connected to each other through the bus. The CPU may access the storage unit 320 to perform booting using an O/S stored in the storage unit 320 and perform various operations using various programs, contents, and data stored in the storage unit 320.

Further, the control unit 330 performs a member joining procedure for a user of the terminal 100 and a user of the advertisement terminal 200 in association with the terminal 100 and the advertisement terminal 200, respectively.

Further, the control unit 330 controls the communication unit 310 to receive one or more multimedia contents, the identification information of the terminal 100 which are transmitted from the terminal 100, and the like.

Further, the control unit 330 extracts (or calculates) feature information in the received multimedia contents.

Further, the control unit 330 recognizes (or discerns) one or more objects included in the first multimedia contents based on the extracted feature information.

That is, the control unit 330 confirms (or compares) a similarity between the extracted feature information and feature information for each of the plurality of objects which is stored (or learned/registered) in advance in the storage unit 320.

Further, the control unit 330 determines (or confirms) whether the confirmed similarity (or similarity between the confirmed and extracted feature information and feature information for each of the plurality of objects) is equal to or higher than a predetermined reference value. That is, the control unit 330 determines whether one or more confirmed similarity is equal to or higher than the predetermined reference value.

As a result of determination, when the confirmed similarity is equal to or higher than the predetermined reference value, the control unit 330 classifies (or determines/confirms) that there is a target object in the first multimedia contents and discerns (or recognizes) the object in the first multimedia contents.

Further, as the result of determination, when the confirmed similarity is lower than the predetermined reference value, the control unit 330 classifies that there is no object in the first multimedia contents.

Further, the control unit 330 generates (or constitutes) first index information (or object relationship information/object relationship table) on the discerned object. Here, the first index information includes an object ID which is set in advance correspondingly to the discerned object and identification information of the terminal 100.

Further, the control unit 330 stores the generated first index information in the storage unit 320 or database (not illustrated) which is an additional constituent element.

Further, the control unit 330 controls the communication unit 310 to receive one or more advertisements transmitted from the advertisement terminal 200. In this case, the advertisement includes multimedia contents related to a specific product, a product ID for the product, an advertisement ID, and priority information.

Further, the control unit 330 controls the communication unit 310 to receive product information, the tracking log information for every terminal, and identification information of the advertisement terminal 200 which are transmitted from the advertisement terminal 200.

Further, the control unit 330 extracts (or calculates) feature information in the received product information.

Further, the control unit 330 recognizes (or discerns) one or more objects included in the product information (or an image in the product information) based on the extracted feature information.

That is, the control unit 330 respectively confirms (or compares) a similarity between the extracted feature information and feature information for each of the plurality of objects which is stored (or learned/registered) in advance in the storage unit 320.

Further, the control unit 330 determines (or confirms) whether the confirmed similarity (or similarity between the confirmed and extracted feature information and feature information for each of the plurality of objects) is equal to or higher than a predetermined reference value. That is, the control unit 330 respectively determines whether the one or more confirmed similarity is equal to or higher than the predetermined reference value.

As a result of determination, when the confirmed similarity is equal to or higher than the predetermined reference value, the control unit 330 classifies (or determines/confirms) that there is an object in the product information and discerns (or recognizes) the object in the product information.

Further, as the result of determination, when the confirmed similarity is lower than the predetermined reference value, the control unit 330 classifies that there is no object in the product information.

Further, the control unit 330 generates (or constitutes) second index information (or object and advertisement relationship information/object and advertisement relationship table) on the discerned object. Here, the second index information includes an object ID which is set in advance correspondingly to the discerned object and an advertisement ID. Further, the advertisement ID may be a unique ID (or a unique ID corresponding to an advertisement related to the discerned object among the plurality of advertisements) corresponding to the advertisement related to the object ID among a plurality of advertisements which is registered in the server 300 in advance.

Further, the control unit 330 stores the generated second index information in the storage unit 320 or database (not illustrated) which is an additional constituent element.

As described above, as a relationship between the first index information (or object relationship information/object relationship table) and the second index information (or object and advertisement relationship information/object and advertisement relationship table) which are generated by the control unit 330, the first index information further includes identification information of the terminal and the second index information further includes the advertisement ID, with respect to the same object ID.

Further, data of the first index information and data of the second index information are individually managed and at the time of actual search, the connection relationship may be confirmed depending on whether the same object ID is included in each index information.

Further, the first index information is generated based on the multimedia contents collected through the camera of the terminal 100 and the second index information is generated based on analysis on the product information provided from the advertisement terminal 200.

Further, for the purpose of each search, the control unit 330 may add indexes to the object IDs in the first index information and the second index information.

Further, the control unit 330 controls the communication unit 310 to receive the advertisement transmitting request signal and the identification information of the terminal 100 which are transmitted from the terminal 100.

Further, the control unit 330 confirms one or more first advertisements corresponding to the tracking log information related to the terminal 100 corresponding to the received identification information of the terminal 100. Here, the tracking log information includes product information which is previously searched by the terminal 100, product view information, cart information (or product information put in a cart of the terminal 100), and order information (or product information for which payment is completed by the terminal 100).

That is, the control unit 330 confirms tracking log information corresponding to the identification information of the terminal 100 which is received through the communication unit 310 among the tracking log information for every terminal which is stored in advance in the storage unit 320.

Further, the control unit 330 confirms one or more first advertisements corresponding to the confirmed tracking log information among the plurality of advertisements which is stored in advance in the storage unit 320. Here, the first advertisement refers to an advertisement confirmed based on the tracking log information.

Further, the control unit 330 confirms at least one advertisement ID matching an object ID in the first index information corresponding to the received identification information of the terminal 100, among the plurality of second index information which is stored in advance in the storage unit 320. Here, the first index information is generated based on the multimedia contents provided from the terminal 100 and includes an object ID which is set in advance correspondingly to the object discerned in the multimedia contents and the identification information of the terminal 100. Further, the second index information includes an object ID which is set in advance correspondingly to the object discerned in the product information provided from the advertisement terminal 200 and the advertisement ID corresponding to the object ID.

Further, the control unit 330 confirms at least one second advertisement corresponding to at least one confirmed advertisement ID respectively among the plurality of advertisements which is stored in advance in the storage unit 320. In this case, the number of confirmed second advertisements may be set by subtracting the number of first advertisement confirmed based on the tracking log information for the terminal 100 from a predetermined total number of advertisements (or a total number of advertisements to be provided to the terminal 100 in response to the advertisement transmitting request signal).

As described above, when the second advertisement is confirmed (or selected), the control unit 330 may preferentially select an advertisement a higher priority based on the priority information for every advertisement (or for every advertisement ID) which is set in advance.

That is, the control unit 330 confirms at least one object ID in the first index information corresponding to the received identification information of the terminal 100, among the plurality of first index information which is stored in advance in the storage unit 320. Further, the control unit 330 confirms at least one advertisement ID corresponding to at least one previously confirmed object ID, among the plurality of second advertisements which is stored in advance in the storage unit 320. Further, the control unit 330 respectively confirms (or searches) at least one second advertisement in a descending order of the priority corresponding to at least one confirmed advertisement ID, respectively, among the plurality of advertisements which is stored in advance in the storage unit 320.

Further, the control unit 330 transmits one or more first advertisement corresponding to the tracking log information and at least one second advertisement corresponding to the advertisement ID to the terminal 100 which transmits the advertisement transmitting request signal through the communication unit 310.

Further, the control unit 330 confirms the advertisement ID whose advertisement period (or a valid period) ends, among the plurality of advertisements stored in the storage unit 320 and deletes the advertisement corresponding to the advertisement ID whose confirmed advertisement period ends from the storage unit 320.

Further, the control unit 330 performs advertisement scheduling on the plurality of advertisements stored in the storage unit 320.

Further, the control unit 330 transmits the performed advertisement scheduling result (or advertisement scheduling data) to one or more terminals 100 accessing (or joined as a member) the server 300 through the communication unit 310.

Further, the control unit 330 may transmit one or more advertisements to a predetermined terminal through the communication unit 310 based on the performed advertisement scheduling result.

As described above, the control unit 330 analyzes the multimedia contents photographed by the terminal 100 to be used as a targeting purpose of the advertisement, to increase a click through rate (CTR) of the advertisement receiver (or the user of the terminal 100) and increase an effective cost per mile (eCPM) therethrough.

The display device 340 may display various contents such as various menu screens using a user interface and/or graphic user interface stored in the storage unit 320, by the control of the control unit 330. Here, the contents displayed on the display unit 340 may include a menu screen including various texts, image data (including various information data), and data such as icons, list menus, or a combo boxes. Further, the display unit 340 may be a touch screen. In this case, a touch sensor which detects a touch gesture of the user may be included. The touch sensor may be any one of various types such as a capacitive type, a decompressive type, or a piezoelectric type. In the case of the capacitive type, when a part of a user's body touches a surface of the touch screen by using a dielectric coated on the surface of the touch screen, a touch coordinate is calculated by sensing minute electricity excited to the user's body. In the case of the decompressive type, two electrode plates are embedded in the touch screen, and when the user touches the screen, upper and lower electrode plates contact each other at the touched position and then current flows, and the touch coordinate is calculated by sensing the flow of the current. In addition to this, the user device supports a pen input function. In this case, a gesture of the user utilizing an input unit such as a pen, rather than the part of the body of the user, may be sensed. For example, when the input unit is a stylus pen in which a coil is included, the user device may include a magnetic field sensor for sensing a magnetic field changed by the coil in the stylus pen. In this case, not only the touch gesture of the user, but also approaching gesture of the user, such as hovering may be detected.

Further, the display unit 340 may be implemented by at least one of a liquid crystal display (LCD), a thin film transistor liquid crystal display (TFT LCD), an organic light emitting diode (OLED), a flexible display, a three dimensional display (3D display), an electronic ink (e-ink) display, and a light emitting diode (LED) and also include a driving circuit therefor and a back light unit together.

Further, the display unit 340 displays the multimedia contents which are transmitted from the terminal 100 by the control of the control unit 330.

Further, the display unit 340 displays the object which is discerned in the multimedia contents by the control of the control unit 330.

Further, the display unit 340 displays the generated first index information (or object relationship information/object relationship table) by the control of the control unit 330.

Further, the display unit 340 displays the advertisement, product information, and the tracking log information for every terminal which are transmitted from the advertisement terminal 200 by the control of the control unit 330.

Further, the display unit 340 displays the object which is discerned in the advertisement or the product information by the control of the control unit 330.

Further, the display unit 340 displays the generated second index information (or object and advertisement relationship information/object and advertisement relationship table) by the control of the control unit 330.

Further, the display unit 340 displays one or more confirmed first advertisements corresponding to the tracking log information, at least one second advertisement (or advertisement information (or the advertisement list) for one or more first advertisements, advertisement information (or the advertisement list) for at least one second advertisement) corresponding to the advertisement ID, and, and the like by the control of the control unit 330.

The voice output unit 350 outputs voice information included in a predetermined signal-processed signal by the control unit 330. Here, the voice output unit 350 may include a receiver, a speaker, a buzzer, and the like.

Further, the voice output unit 350 outputs a guidance voice generated by the control unit 330.

Further, the voice output unit 350 outputs voice information corresponding to the multimedia contents, the advertisement, the product information, the tracking log information, and the like, respectively, by the control unit 330.

Further, the server 300 may be implemented in a form such as a web server, a database server, and a proxy server. Further, in the server 300, one or more of various software which allows a network load distribution mechanism or a service providing device 300 to operate on the Internet or other networks may be installed, and as a result, the server 300 may be implemented by a computerized system. Further, the network may be an http network and may be a private line, Intranet, or any other networks. Furthermore, the server 300, the terminal 100, and the advertisement terminal 200 may be connected to each other by a security network so as to suppress the data from being attacked by any hacker or other third parties. Further, the server 300 may include a plurality of database servers. The database server may be implemented to be separately connected with the server 300 through any type of network connection including a distributed database server architecture.

Further, a processor mounted in the terminal 100, the advertisement terminal 200, or the server 300 according to the exemplary embodiment of the present invention may process the program command to execute the method according to the exemplary embodiment of the present invention. In an implemented embodiment, the processor may be a single-threaded processor. In another implemented embodiment, the processor may be a multi-threaded processor. Further, the processor may process the command stored on the memory or the storage device.

As described above, when the terminal requests an advertisement, a tracking log including information on an advertisement and the like which is previously searched by the terminal and an advertisement related to an object corresponding to a unique ID of the objects which is registered in advance in the advertisement terminal, which matches the unique ID of the object corresponding to the unique identification information of the terminal, are provided to the corresponding terminal.

Hereinafter, a control method of an object recognition based retargeting advertisement product recommending system according to an exemplary embodiment of the present invention will be described in detail with reference to FIGS. 1 to 10.

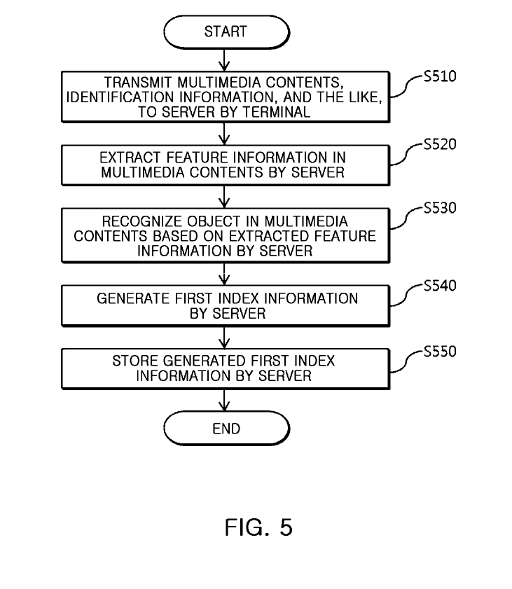

FIG. 5 is a flowchart illustrating a control method of an object recognition based retargeting advertisement product recommending system according to a first embodiment of the present invention.

First, when an application which is installed in advance in a terminal 100 is executed or the terminal 100 accesses a server 300, the terminal 100 transmits one or more multimedia contents which are stored in advance in the terminal 100, identification information of the terminal 100, and the like to the server 300. Here, the multimedia contents include an image and a moving image. Further, the identification information of the terminal 100 includes a mobile directory number (MDN), a mobile IP, a mobile MAC, a subscriber identify module (Sim) card unique information, and a serial number.

For example, when a predetermined contents transmitting menu (or a contents transmitting button) on the application is selected after executing the application which is installed in advance in the terminal 100, the terminal 100 transmits first multimedia contents corresponding to an image, identification information of the terminal 100, and the like to the server 300. In this case, a women's clothing which is photographed by a camera equipped in the terminal 100 may be included in the image (S510).

Next, the server 300 receives one or more multimedia contents transmitted from the terminal 100, identification information of the terminal 100, and the like.

Further, the server 300 extracts (or calculates) feature information in the received multimedia contents.

For example, the server 300 extracts one or more feature information (for example, including a color, a shape, or a form) in an image corresponding to the received first multimedia contents (S520).

Next, the server 300 recognizes (or discerns) one or more objects included in the first multimedia contents based on the extracted feature information.

That is, the server 300 respectively confirms (or compares) a similarity between the extracted feature information and feature information for each of the plurality of objects which is stored (or learned/registered) in advance in the server 300.

Further, the server 300 determines (or confirms) whether the confirmed similarity (or similarity between the confirmed and extracted feature information and feature information for each of the plurality of objects) is equal to or higher than a predetermined reference value. That is, the server 300 respectively determines whether the one or more confirmed similarity is equal to or higher than the predetermined reference value.

As a result of determination, when the confirmed similarity is equal to or higher than the predetermined reference value, the server 300 classifies (or determines/confirms) that there is a target object in the first multimedia contents and discerns (or recognizes) the object in the first multimedia contents.

Further, as the result of determination, when the confirmed similarity is lower than the predetermined reference value, the server 300 classifies that there is no object in the first multimedia contents.

For example, the server 300 respectively confirms a similarity between the extracted feature information and the plurality of feature information for every object stored in advance in the server 300. Further, the server 300 respectively determines whether the OO confirmed similarities are equal to or higher than the predetermined reference value. As the result of determination, when there is a similarity which is equal to or higher than a predetermined reference value, among the confirmed OO similarities, the server 300 discerns the women's clothing, which is the corresponding object, in the image corresponding to the first multimedia contents, based on the plurality of feature information which is learned in advance, corresponding to a similarity which is equal to or higher than the predetermined reference value, among the confirmed OO similarities. Further, as the result of determination, when the confirmed OO similarities are lower than the predetermined reference value, the server 300 classifies that there is no object in the image corresponding to the first multimedia contents (S530).

Next, the server 300 generates (or constitutes) first index information (or object relationship information/object relationship table) on the discerned object. Here, the first index information includes an object ID which is set in advance correspondingly to the discerned object and identification information of the terminal 100.

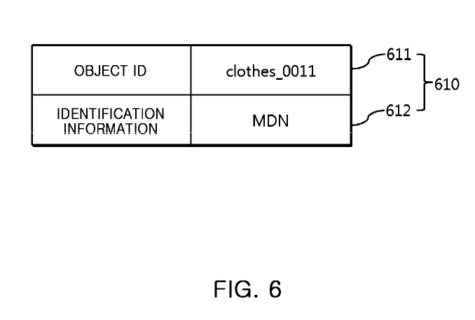

As an example, as illustrated in FIG. 6, the server 300 generates an object ID 611 (for example, including clothes_0011) which is set in advance correspondingly to the discerned women's clothing and first index information 610 including the previously received identification information 612 of the terminal 100 (S540).

Further, the server 300 stores the generated first index information in the server 300 (or database (not illustrated) which is an additional constituent element).

For example, the server 300 stores the first index information including the object ID (for example, including clothes_0011) which is set in advance correspondingly to the discerned women's clothing and the identification information of the terminal in the database (S550).

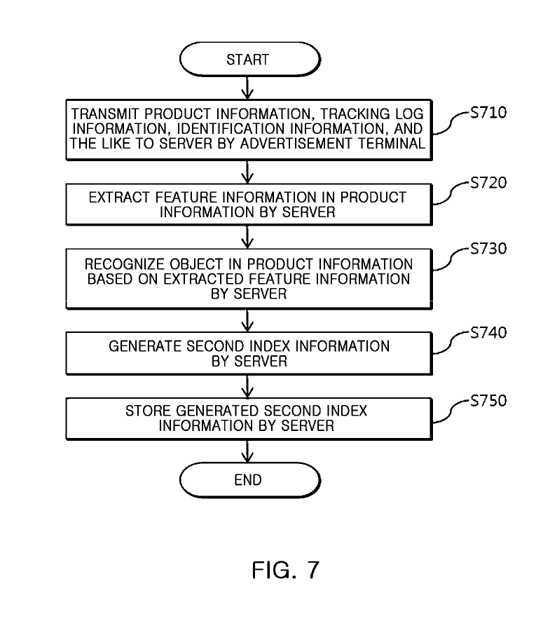

FIG. 7 is a flowchart illustrating a control method of an object recognition based retargeting advertisement product recommending system according to a second embodiment of the present invention.

First, when the application which is installed in advance in the advertisement terminal 200 is executed or the advertisement terminal 200 accesses the server 300, the advertisement terminal 200 transmits a plurality of (or one or more) product information which is stored in advance in the advertisement terminal 200, tracking log information for every terminal, identification information of the advertisement terminal 200, and the like to the server 300. Here, the product information includes a product name, a product image, and product description information. Further, the tracking log information includes product information searched by the specific terminal 100, product view information, cart information (or product information put in a cart of the specific terminal), and order information (or product information for which payment is completed by the specific terminal).

For example, when a predetermined information transmitting menu (or an information transmitting button) on the application is selected after executing the application which is installed in advance in the advertisement terminal 200, the advertisement terminal 200 transmits first to tenth product information, first to fifth tracking log information corresponding to first to fifth terminals 100, respectively, identification information of the advertisement terminal 200, and the like to the server 300 (S710).

Thereafter, the server 300 receives product information, the tracking log information for every terminal, and the identification information of the advertisement terminal 200 which are transmitted from the advertisement terminal 200.

Further, the server 300 extracts (or calculates) feature information in the received product information.

For example, the server 300 respectively extracts one or more feature information (for example, including a color, a shape, or a form) from first to tenth images included in the received first to tenth product information (S720).

Thereafter, the server 300 recognizes (or discerns) one or more objects included in the product information (or an image in the product information) based on the extracted feature information.

That is, the server 300 respectively confirms (or compares) a similarity between the extracted feature information and feature information for each of the plurality of objects which is stored (or learned/registered) in advance in the server 300.

Further, the server 300 determines (or confirms) whether the confirmed similarity (or similarity between the confirmed and extracted feature information and feature information for each of the plurality of objects) is equal to or higher than a predetermined reference value. That is, the server 300 determines whether the one or more confirmed similarity is equal to or higher than the predetermined reference value.

As a result of determination, when the confirmed similarity is equal to or higher than the predetermined reference value, the server 300 classifies (or determines/confirms) that there is an object in the product information and discerns (or recognizes) the object in the product information.

Further, as the result of determination, when the confirmed similarity is lower than the predetermined reference value, the server 300 classifies that there is no object in the product information.

For example, the server 300 respectively confirms a similarity between the feature information extracted from a first image included in the first product information and the plurality of feature information for every object stored in advance in the server 300. Further, the server 300 respectively determines whether the confirmed III similarities are equal to or higher than the predetermined reference value. As a result of determination, when there is a similarity which is equal to or higher than the predetermined reference value, among the confirmed III similarities, the server 300 discerns men's shoes as the object in the first image included in the first product information based on a plurality of previously learned feature information corresponding to the similarity which is equal to or higher than the reference value. Further, as the result of determination, when all the confirmed □□ similarities are lower than the predetermined reference value, the server 300 classifies that there is no object in the first image included in the first product information (S730).

Further, the server 300 generates (or constitutes) second index information (or object and advertisement relationship information/object and advertisement relationship table) on the discerned object. Here, the second index information includes an object ID which is set in advance correspondingly to the discerned object and an advertisement ID. Further, the advertisement ID may be a unique ID (or a unique ID corresponding to an advertisement related to the discerned object among the plurality of advertisements) corresponding to the advertisement related to the object ID among a plurality of advertisements which is registered in the server 300 in advance.

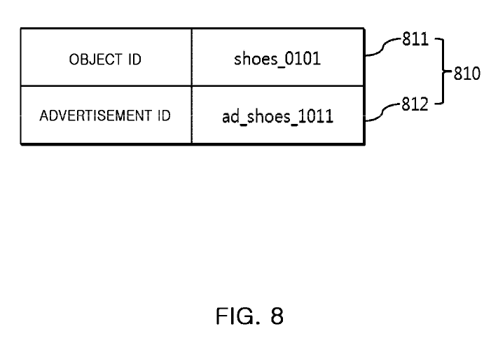

For example, as illustrated in FIG. 8, the server 300 generates second index information 810 including an object ID 811 (for example, including shoes_0101) which is set in advance correspondingly to discerned men's shoes and one or more advertisements ID 812 (for example, including ad_shoes_1011, ad_shoes_1012, and ad_shoes_1013) corresponding to the advertisement related to the men's shoes (or the object ID) (S740).

Next, the server 300 stores the generated second index information in the server 300 (or database (not illustrated) which is an additional constituent element).

For example, the server 300 stores the second index information including an object ID (for example, including shoes_0101) which is set in advance correspondingly to discerned men's shoes and one or more advertisements ID (for example, including ad_shoes_1011, ad_shoes_1012, and ad_shoes_1013) corresponding to the advertisement related to the men's shoes (or the object ID) in the database (S750).

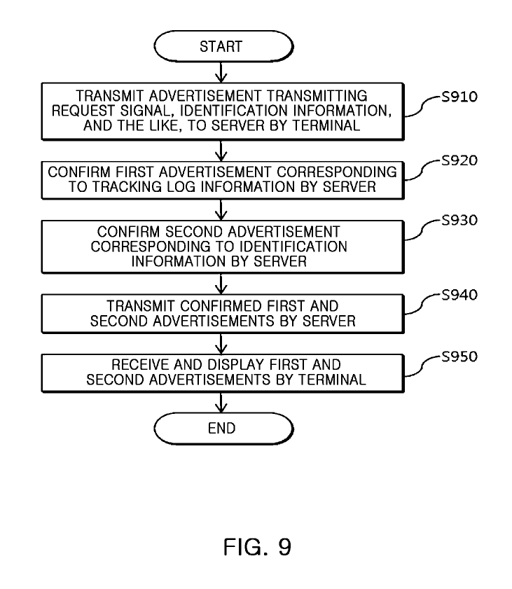

FIG. 9 is a flowchart illustrating a control method of an object recognition based retargeting advertisement product recommending system according to a third embodiment of the present invention.

First, in a state when the application which is installed in advance in the terminal 100 is executed or the terminal 100 accesses the server 300, if an advertisement transmitting request menu (alternatively, an advertisement transmitting request button) which is set in advance in the application is selected, the terminal 100 generates an advertisement transmitting request signal. Further, the terminal 100 transmits the generated advertisement transmitting request signal, the identification information of the terminal 100, and the like to the server 300. Here, the identification information of the terminal 100 includes a mobile directory number (MDN), a mobile IP, a mobile MAC, a subscriber identify module (Sim) card unique information, and a serial number.

For example, when a predetermined advertisement transmitting request menu on the application is selected after executing the application which is installed in advance in the terminal 100, the terminal 100 generates an advertisement transmitting request signal to request to transmit the advertisement. Further, the terminal 100 transmits the generated advertisement transmitting request signal, the identification information of the terminal 100, and the like to the server 300 (S910).

Next, the server 300 receives the advertisement transmitting request signal and identification information of the terminal 100 which are transmitted from the terminal 100.

Further, the server 300 confirms one or more first advertisements corresponding to the tracking log information related to the terminal 100 corresponding to the received identification information of the terminal 100. Here, the tracking log information includes product information which is previously searched by the terminal 100, product view information, cart information (or product information put in a cart of the terminal 100), and order information (or product information for which payment is completed by the terminal 100).

That is, the server 300 confirms the tracking log information corresponding to the received identification information of the terminal 100 among the tracking log information for every terminal which is stored in advance. Further, the server 300 confirms one or more first advertisements corresponding to the confirmed tracking log information among the plurality of advertisements which is stored in advance.

For example, the server 300 confirms three advertisements corresponding to the women's clothing which is previously searched by means of the terminal 100 and the men's shoes for which the payment is completed by means of the terminal 100, included in the tracking log information related to the terminal 100 corresponding to the identification information of the terminal, among a plurality of advertisements which is stored (or registered/linked) in advance.

As another example, the server 300 confirms eleventh tracking log information corresponding to the received identification information of the terminal 100 among the tracking log information for every terminal which is stored in advance. Further, the server 300 confirms three advertisements corresponding to the women's clothing which is previously searched by means of the terminal 100 and the men's shoes for which the payment is completed by means of the terminal 100, included in the confirmed eleventh tracking log information, among a plurality of advertisements which is stored in advance (S920).

Next, the server 300 confirms at least one advertisement ID matching an object ID in the first index information corresponding to the received identification information of the terminal 100, among the plurality of second index information which is stored in advance. Further, the server 300 confirms at least one second advertisement corresponding to at least one confirmed advertisement ID. In this case, the number of confirmed second advertisements may be set by subtracting the number of first advertisement confirmed based on the tracking log information for the terminal 100 from a predetermined total number of advertisements (or a total number of advertisements to be provided to the terminal 100 in response to the advertisement transmitting request signal). Here, the first index information is generated based on the multimedia contents provided from the terminal 100 and includes an object ID which is set in advance correspondingly to the object discerned in the multimedia contents and the identification information of the terminal 100. Further, the second index information includes an object ID which is set in advance correspondingly to the object discerned in the product information provided from the advertisement terminal 200 and the advertisement ID corresponding to the object ID.

As described above, when the second advertisement is confirmed (or selected), the server 300 may preferentially select an advertisement a higher priority based on the priority information for every advertisement (or for every advertisement ID) which is set in advance.

That is, the server 300 confirms at least one object ID in the first index information corresponding to the received identification information of the terminal 100, among the plurality of first index information which is stored in advance. Further, the server 300 confirms at least one advertisement ID corresponding to at least one confirmed object ID, among the plurality of second advertisements which is stored in advance. Further, the server 300 respectively confirms at least one second advertisement corresponding to at least one confirmed advertisement ID respectively among the plurality of advertisements which is stored in advance.

That is, the server 300 confirms eleventh to sixteenth object IDs corresponding to the received identification information of the terminal 100, among the plurality of first index information which is stored in advance. Here, the eleventh to sixteenth object IDs may be object IDs corresponding to the women's clothing which is previously searched by means of the terminal 100, the men's shoes for which the payment is completed by the terminal 100, and the like. Further, the server 300 confirms twenty first to twenty sixth advertisement IDs corresponding to the confirmed eleventh to sixteenth object IDs among the plurality of second index information which is stored in advance. Further, with respect to the women's clothing and the men's shoes, the server 300 confirms six advertisements corresponding to the confirmed twenty first to twenty sixth advertisement IDs among the plurality of advertisements which is stored in advance. In this case, when the total number of advertisements to be provided to the terminal 100 in response to the advertisement transmitting request signal is nine and the number of first advertisements previously confirmed based on the tracking log information is three, a total of six advertisements may be confirmed based on the confirmed advertisement ID. Further, when the total number of advertisements to be provided to the terminal 100 in response to the advertisement transmitting request signal is seven and the number of first advertisements previously confirmed based on the tracking log information is three, a total of four advertisements (for example, four advertisements corresponding to twenty first to twenty fourth advertisement IDs which have higher priorities respectively among the confirmed twenty first to twenty sixth advertisements IDs) may be confirmed based on the confirmed advertisement ID (S930).

Next, the server 300 transmits one or more first advertisement corresponding to the confirmed tracking log information and at least one second advertisement corresponding to the confirmed advertisement ID to the terminal 100 which transmits the advertisement transmitting request signal.

As an example, the server 300 transmits three advertisements confirmed based on the women's clothing which is previously searched by means of the terminal 100, the men's shoes for which the payment is completed by means of the terminal 100, and the like included in the tracking log information related to the terminal 100 and six advertisements confirmed based on the advertisement ID to the terminal (S940).

Next, the terminal 100 receives one or more first advertisements corresponding to the tracking log information which is transmitted from the server 300 in response to the transmitted advertisement transmitting request signal and is confirmed in the server 300, at least one second advertisement corresponding to the advertisement ID confirmed in the server 300, and the like.

Further, the terminal 100 displays one or more first advertisements corresponding to the received tacking log information, at least one second advertisement corresponding to the advertisement ID, and the like.

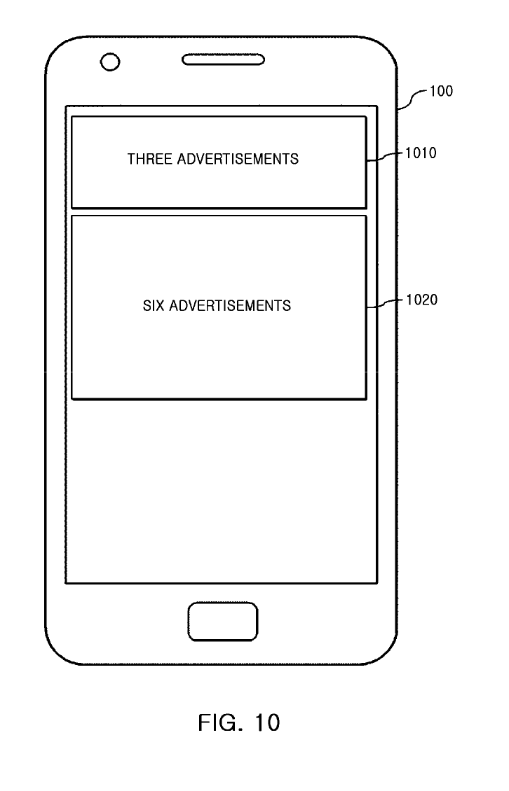

For example, as illustrated in FIG. 10, the terminal 100 displays three advertisements 1010 corresponding to the tacking log information confirmed in the terminal 100 and six advertisements 1020 confirmed based on the advertisement ID (S950).

As described above, the server 300 confirms (or searches) an advertisement corresponding to an object in the multimedia contents provided from the specific terminal 100, among a plurality of advertisements which is registered in advance in the server 300 in relation with the specific object by the advertisement terminal 200 and provides the confirmed advertisement to the terminal 100, thereby providing a retargeted advertisement product to the terminal 100 using an object correlation between the multimedia contents photographed by the terminal 100 and an advertisement (or an advertisement material) provided from the advertisement terminal 200.

The virtual object recognition based retargeting advertisement product recommending terminal, the server, and the advertisement product recommending system including the same according to the embodiment of the present invention may be prepared with a computer program, and codes and code segments configuring the computer program may easily deduced by a computer programmer in the art. Further, the corresponding computer program is stored in a non-transitory computer readable storage medium, and read and executed by the computer, the terminal, the advertisement terminal, and the server according to the embodiment of the present invention to implement the object recognition based retargeting advertisement product recommending terminal, the server, and the advertisement product recommending system including the same.

The non-transitory computer readable storage medium includes a magnetic recording medium, an optical recording medium, and a carrier wave medium. The computer program implementing the object recognition based retargeting advertisement product recommending terminal, the server, and the advertisement product recommending system including the same according to the embodiment of the present invention may be stored and installed in embedded memories of the terminal, the advertisement terminal, the server, and the like. Alternatively, external memories such as a smart card storing and installing the computer program implementing the object recognition based retargeting advertisement product recommending terminal, the server, and the advertisement product recommending system including the same according to the embodiment of the present invention may be installed on the terminal, the advertisement terminal, the server, and the like through an interface.

As described above, according to the present invention, when a terminal requests an advertisement, a tracking log including information on an advertisement, and the like, which has been searched before in the terminal and an advertisement related to an object corresponding to a unique ID of the object which is registered in advance in an advertising terminal matching a unique ID of the object corresponding to unique identification information of the terminal are provided to the terminal. Therefore, an advertisement suitable for a user may be transmitted through intuitive analysis of a favorable impression of a product of an advertisement receiver and thus an advertisement effect is increased. Further, a high purchasing rate may be achieved by providing advertisement on a product necessary in the daily life.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments, and the following claims as well as all modified equally or equivalently to the claims are intended to fall within the scope and spirit of the invention.

### INDUSTRIAL APPLICABILITY

According to the embodiment of the present invention, when a terminal requests an advertisement, a tracking log including information on an advertisement, and the like which has been searched before in the terminal and an advertisement related to an object corresponding to a unique ID of the object which is registered in advance in an advertising terminal matching a unique ID of the object corresponding to unique identification information of the terminal are provided to the terminal. Therefore, an advertisement suitable for a user may be transmitted through intuitive analysis of a favorable impression of a product of an advertisement receiver and thus an advertisement effect is increased. Further, a high purchasing rate may be achieved by providing advertisement on a product necessary in the daily life. As a result, the present invention can be widely used in a terminal field, an advertisement field, and a retargeting product recommendation field.

1. An object recognition based retargeting advertisement product recommending server, the server comprising:
a communication unit which receives an advertisement transmitting request signal and identification information of the terminal which are transmitted from a terminal;
a storage unit which stores a plurality of first index information including a plurality of object IDs corresponding to objects discerned in multimedia contents and identification information, a plurality of second index information including a plurality of object IDs corresponding to objects discerned in product information and advertisement IDs corresponding to the object IDs, a plurality of advertisements, and tracking log information for every terminal; and
a control unit which confirms one or more first advertisements and at least one second advertisement based on at least one of the identification information of the terminal, the plurality of first index information, the plurality of second index information, the plurality of advertisements, and the tracking log information for every terminal, and controls the communication unit to transmit the confirmed one or more first advertisements and at least one second advertisement to the terminal.

2. The server of claim 1, wherein the control unit confirms tracking log information corresponding to the received identification information of the terminal among the tracking log information for every terminal and confirms one or more first advertisements corresponding to the confirmed tracking log information among the plurality of advertisements which is stored in advance in the storage unit.

3. The server of claim 1, wherein the control unit confirms at least one object ID in first index information corresponding to the identification information of the terminal among the plurality of first index information, confirms at least one advertisement ID corresponding to at least one confirmed object ID, respectively, among the plurality of second index information, and confirms at least one second advertisement corresponding to the at least one confirmed advertisement ID, respectively, among the plurality of advertisements which is stored in advance in the storage unit.

4. The server of claim 1, wherein the tracking log information includes at least one of product information which is previously searched by a specific terminal, product view information, product information put in a cart of the specific terminal, and product information for which payment is completed by the specific terminal.

5. The server of claim 1, wherein the control unit extracts feature information in the multimedia contents, discerns an object included in the multimedia contents based on the extracted feature information, generates the first index information including an object ID which is set in advance correspondingly to the discerned object and the identification information of the terminal, and stores the generated first index information in the storage unit.

6. The server of claim 1, wherein the control unit extracts feature information in product information transmitted from an advertisement terminal, discerns an object included in the product information based on the extracted feature information, generates the second index information including an object ID which is set in advance correspondingly to the discerned object and an advertisement ID which is set in advance correspondingly to the object ID, and stores the generated second index information in the storage unit.

7. A control method of an object recognition based retargeting advertisement product recommending server, the control method comprising:
receiving an advertisement transmitting request signal and identification information of the terminal which are transmitted from a terminal, by means of a communication unit;
confirming one or more first advertisements based on tracking log information for every terminals which is stored in advance in a storage unit and the identification information of the terminal, by means of a control unit;
confirming at least one advertisement ID matching an object ID in first index information corresponding to the identification information of the terminal among a plurality of second index information which is stored in advance in the storage unit and confirming at least one second advertisement corresponding to the confirmed at least one advertisement ID, by means of the control unit; and
transmitting the confirmed one or more first advertisements and at least one second advertisement to the terminal, by means of the communication unit.

8. The control method of claim 7, wherein the confirming of one or more first advertisements includes:
confirming tracking log information corresponding to the received identification information of the terminal among the tracking log information for every terminal, by means of the control unit; and
confirming one or more first advertisements corresponding to the confirmed tracking log information, among the plurality of advertisement which is stored in advance in the storage unit.

9. The control method of claim 7, wherein the confirming of at least one second advertisement includes:
confirming at least one object ID in first index information corresponding to the identification information of the terminal, among a plurality of first index information;
confirming at least one advertisement ID corresponding to the confirmed at least one object ID, respectively, among the plurality of second index information; and
confirming at least one second advertisements corresponding to the confirmed at least one advertisement ID, respectively, among the plurality of advertisement which is stored in advance in the storage unit.

10. A non-transitory computer readable storage medium having a computer program recorded thereon configured to perform the method according to claim 7.

11. A non-transitory computer readable storage medium having a computer program recorded thereon configured to perform the method according to claim 8.

12. A non-transitory computer readable storage medium having a computer program recorded thereon configured to perform the method according to claim 9.
